(19) United States
(12) Patent Application Publication
(10) Pub. No.: US 2010/0138888 A1
(43) Pub. Date: Jun. 3, 2010

(54) Receiver and Receiving Method

(75) Inventors: Hiroshi Kawada, Tachikawa (JP); Gen Omura, Ome (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/498,258

(22) Filed: Jul. 6, 2009

(30) Foreign Application Priority Data
Dec. 2, 2008 (JP) 2008-307903

(51) Int. Cl. H04N 7/173; H04N 5/445; H04L 12/28

(52) U.S. Cl. 725/110; 348/563; 370/390; 348/E05.099

(57) ABSTRACT

According to one embodiment, a receiver is connected via a communication network to a broadcast server that transmits a plurality of programs broadcast via the Internet. The receiver includes a storage module, a receiving module, a connection processor, a display module, and a determination module. The storage module stores channels of the programs. The receiving module receives input specifying a first program, from among the programs, to be viewed. The connection processor receives the first program or a second program that is automatically transmitted from the broadcast server from among the programs. The display module displays the first program or the second program. The determination module determines whether the display module displays the first program, and, when determining that the display module displays the first program, stores the channel of the first program in the storage module.

### CROSS-REFERENCE TO RELATED APPLICATIONS

This application is based upon and claims the benefit of priority from Japanese Patent Application No. 2008-307903, filed on Dec. 2, 2008, the entire contents of which are incorporated herein by reference.

### BACKGROUND

1. Field

One embodiment of the invention relates to a technology for receiving broadcast data, and more particularly, to a receiver that stores the channel of a broadcast program or the like and a receiving method.

2. Description of the Related Art

A commonly used receiver that receives broadcasts such as television receivers generally stores in its memory or the like a channel (last channel) when turned off to eliminate the user's need to change the channel at the time the user turns on the receiver again.

The receiver operates similarly when receiving digital broadcasts such as terrestrial digital broadcasts and ES digital broadcasts as well as analog broadcasts. For example, Japanese Patent Application Publication (KOKAI) No. S63-50173 discloses a conventional technology in which, in an area where the last channel specified by the user is not broadcast, a channel broadcast in the area is automatically stored as the last channel.

In recent broadcast services, in addition to the broadcast of programs through broadcast waves from broadcast stations, the broadcast of programs through an Internet protocol (IP) network, i.e., IP broadcast, has become popular. Some IP broadcast providers even have its own portal site.

On the script that displays a Web page or the portal site, there is such a case that a multicast address is specified to receive an IP broadcast program (for example, a promotion program) and, when the user accesses the portal site, the program is automatically received.

The program automatically received in this manner, however, is not always the one that the user wishes to view. In other words, since an IP broadcast program is automatically received due to access to the portal site, even when the user just accesses the portal site but does not view the IP broadcast program, the receiver may store the channel of the IP broadcast program as the last channel.

Besides, when the user selects a program on the portal site to view, even while he/she is viewing the program in the main window on the portal site, the sub window may display a program such as a promotion program that is not intended by the user. In this case, even after the user has completed to view the program in the main window, the sub window sometimes continues to display the program that is not intended by the user. This also results in that the channel that is not intended by the user is stored as the last channel.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of an IP broadcast system according to a first embodiment of the invention;

FIG. 2 is an exemplary functional block diagram of a receiver in the first embodiment;

FIG. 3 is an exemplary schematic diagram of a program displayed on the entire screen of a display module in the first embodiment;

FIG. 4 is an exemplary schematic diagram of a program displayed in a sub window on a browser screen displayed on the display module in the first embodiment;

FIG. 5 is an exemplary flowchart of a process performed by the receiver from when it receives an IP broadcast program until it stores the last channel in the first embodiment;

FIG. 6 is an exemplary functional block diagram of a receiver according to a second embodiment of the invention;

FIG. 7 is an exemplary schematic diagram of a program that a graphics processor displays in a main window in the second embodiment;

FIG. 8 is an exemplary schematic diagram for explaining the case where programs are switched between the main window and the sub window in the second embodiment;

FIG. 9 is an exemplary flowchart of a process performed by the receiver from when it receives an IP broadcast program until it stores the last channel in the second embodiment;

FIG. 10 is an exemplary functional block diagram of a receiver according to a third embodiment of the invention;

FIG. 11 is an exemplary flowchart of a process performed by the receiver from when it receives an IP broadcast program until it stores the last channel in the third embodiment;

FIG. 12 is an exemplary flowchart of a combination of the processes of the first embodiment and the third embodiment; and

FIG. 13 is an exemplary schematic diagram of the main window displayed on the entire on a browser screen according to an embodiment of the invention.

### DETAILED DESCRIPTION

Various embodiments according to the invention wilt be described hereinafter with reference to the accompanying drawings. In general, according to one embodiment of the invention, a receiver is connected via a communication network to a broadcast server that transmits a plurality of programs broadcast via the Internet. The receiver comprises a storage module, a receiving module, a connection processor, a display module, and a determination module. The storage module is configured to store channels of the programs. The receiving module is configured to receive input specifying a first program, from among the programs, to be viewed. The connection processor is configured to receive the first program or a second program that is automatically transmitted from the broadcast server from among the programs. The display module is configured to display the first program or the second program. The determination module is configured to determine whether the display module displays the first program, and, when determining that the display module displays the first program, store the channel of the first program in the storage module.

According to another embodiment of the invention, there is provided a receiving method applied to a receiver that is connected via a communication network to a broadcast server that transmits a plurality of programs broadcast via the Internet and that comprises a storage module configured to store channels of the programs and a display module configured to display a first program specified from among the programs or a second program automatically transmitted from the broadcast server. The receiving method comprises: a receiving module receiving input specifying the first program to be viewed; a connection processor receiving the first program or the second program; and determination module determining whether the display module displays the first program, and, when determining that the display module displays the first program, storing the channel of the first program in the storage module.

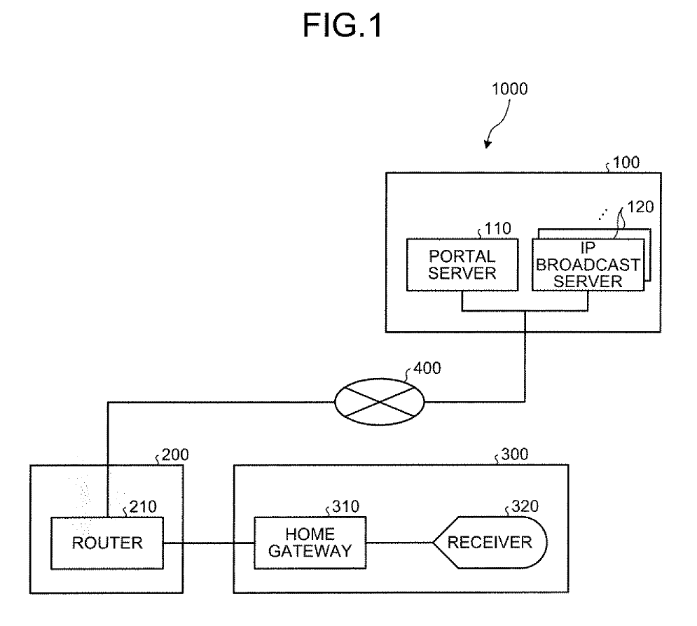

FIG. 1 is a block diagram of an Internet protocol (IP) broadcast system 1000 according to a first embodiment of the invention. As illustrated in FIG. 1, the IP broadcast system 1000 comprises a sender system 100, a local station 200, a receiver system 300, and a network 400.

The sender system 100 is constructed by an IP broadcast provider or the like to provide IP broadcast services. As illustrated in FIG. 1, the sender system 100 comprises a portal server 110 and an IP broadcast server 120.

The portal server 110 transmits, in response to a connection request from the user, a script such as a Web page and content provided by a provider to a receiver 320, which will be described later, through the local station 200 and the network 400.

In the following, it is assumed that the portal server 110 transmits a script for displaying a Web page of a portal site in response to a connection request from the receiver 320, which will be described later. It is also assumed that a multicast address is embedded in the transmitted script to allow the IP broadcast server 120, which will be described later, to perform the stream distribution of programs to be provided. The multicast address is embedded in advance in the script for, for example, the IP broadcast of a promotion program.

Upon receipt of a request specifying a multicast address from the receiver 320, the IP broadcast server 120 transmits a program of a channel corresponding to the multicast address to the receiver 320. As illustrated in FIG. 1, there may be a plurality of the IP broadcast servers 120 each for each of multicast addresses (IP broadcast channels).

The term “IP broadcast” refers to a form of service to provide a program and the like by IP multicast. Specifically, a device that transmits an IP broadcast assigns a multicast address to each of channels of programs to be broadcast, and transmits the programs to a multicast router that constitutes a multicast group. On the other hand, a device that receives the IP broadcast transmits a corresponding multicast address to the multicast router to receive the IP broadcast. In this manner, the user can view an IP broadcast by transmitting a corresponding multicast address to the multicast router.

More specifically, according to a protocol such as Internet group management protocol (IGMP) in IP version 4 (IPv4) and multicast listener discovery (MLD) in IPv6, the device on the receiving side transmits a request (hereinafter, “join request”) to join the multicast group defined by IGMP or the like to the multicast router together with the multicast address of a program desired to receive.

According to a routing protocol such as protocol independent multicast (PIM), the multicast router specifies a route from the device on the transmitting side to the device on the receiving side. The multicast router then starts transmitting the program to the device on the receiving side in response to the join request received therefrom. Incidentally, it is assumed that the device on the receiving side stores in advance the multicast address and information on a channel corresponding to the multicast address in its memory or the like.

Meanwhile, to stop viewing an IP broadcast, the device on the receiving side transmits a request (hereinafter, “leave request”) to leave the multicast group to the multicast router, thereby completing to receive a program or the like. Accordingly, the multicast router terminates the transmission of the program.

Although the portal server 110 and the IP broadcast server 120 are described herein as physically different servers, a single server may function as both the portal server 110 and the IP broadcast server 120. In the following, the local station 200 will be described.

The local station 200 intermediates communication between the sender system 100 and the receiver system 300. The local station 200 comprises a router 210.

The router 210 is a multicast router that can handle multicast communication. The router 210 controls multicast communication between the sender system 100 and the receiver system 300 as well as intermediating communication between them.

More specifically, upon receipt of a join request from the receiver 320 together with the multicast address of a program or the like desired to be received via IP broadcast, the router 210 specifies a route to the IP broadcast server 120. The router 210 receives the program specified by the multicast address from the IP broadcast server 120, and forwards the program to the receiver 320 in response to the join request.

On the other hand, upon receipt of a leave request from the receiver 320, the router 210 stops forwarding the program from the IP broadcast server 120, thereby terminating the transmission of the program. Next, the receiver system 300 will be described.

The receiver system 300 is connected to LAN or the like in the home of the user who views a program. The receiver system 300 comprises a home gateway 310 and the receiver 320.

The home gateway 310 intermediates communication between the receiver 320 and the router 210, and performs processing such as communication protocol conversion.

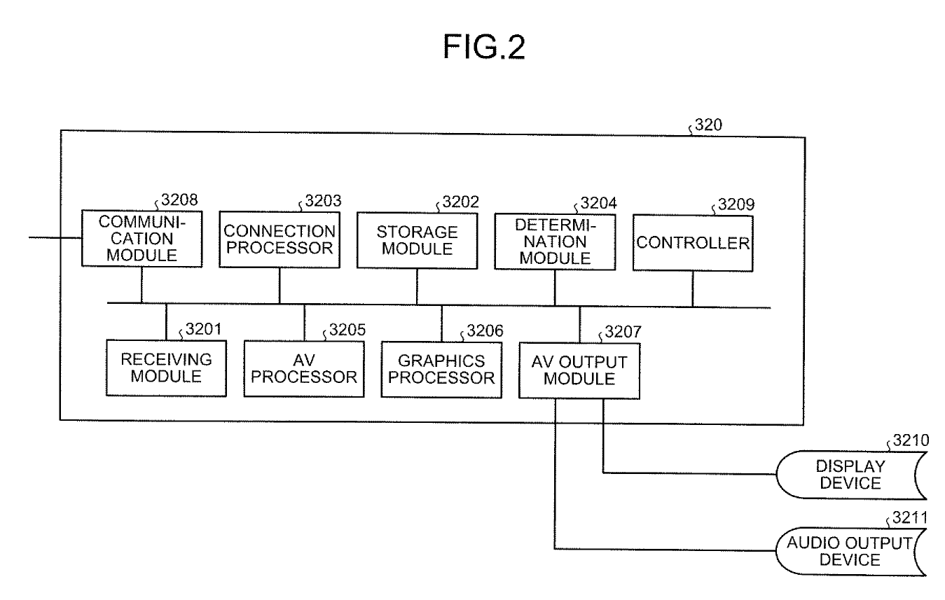

The receiver 320 may be, for example, a set-top box (STB) that receives a script to display a Web page of a portal site from the portal server 110 or an IP broadcast program from the IP broadcast server 120. FIG. 2 is a functional block diagram of the receiver 320.

As illustrated in FIG. 2, the receiver 320 comprises a receiving module 3201, a storage module 3202, a connection processor 3203, a determination module 3204, an AV processor 3205, a graphics processor 3206, an AV output module 3207, a communication module 3208, and a controller 3209. The receiver 320 is connected to a display device 3210 and an audio output device 3211.

While the receiver 320 is in a mode (standby mode) in which it is capable of receiving an IP broadcast, the receiving module 3201 receives a first signal indicating that an IP broadcast is to be viewed or a second signal instructing to connect to a portal site from the outside such as a remote controller (not illustrated).

Further, upon receipt of a power ON signal to turn on the receiver 320 from a power button (not illustrated), the receiver 320 turns on the receiver 320 and brings it into standby mode.

The storage module 3202 is a storage medium such as memory that stores an multicast address in association with a channel to view a program. The storage module 3202 also stores a channel selected immediately before the receiver 320 is turned off (hereinafter, “last channel”). Cases where the storage module 3202 stores the last channel will be described later.

Further, as will be described later, the storage module 3202 stores various programs such as a browser to display a Web page of a portal site when the receiver 320 is connected to the portal server 110.

Depending on a signal received by the receiving module 3201, the connection processor 3203 determines whether to connect the receiver 320 to the portal server 110 via the router 210 or to receive an IP broadcast from the IP broadcast server 120 via the router 210.

More specifically, the connection processor 3203 determines whether the signal received by the receiving module 3201 is the first signal or the second signal. When determining that the receiving module 3201 has received the first signal, the connection processor 3203 reads a channel stored in the storage module 3202.

In addition, the connection processor 3203 issues a join request to connect to the IP broadcast server 120 with a multicast address corresponding to the channel read from the storage module 3202. Thus, the connection processor 3203 receives a program from the IP broadcast server 120 to which the connection processor 3203 has sent the join request.

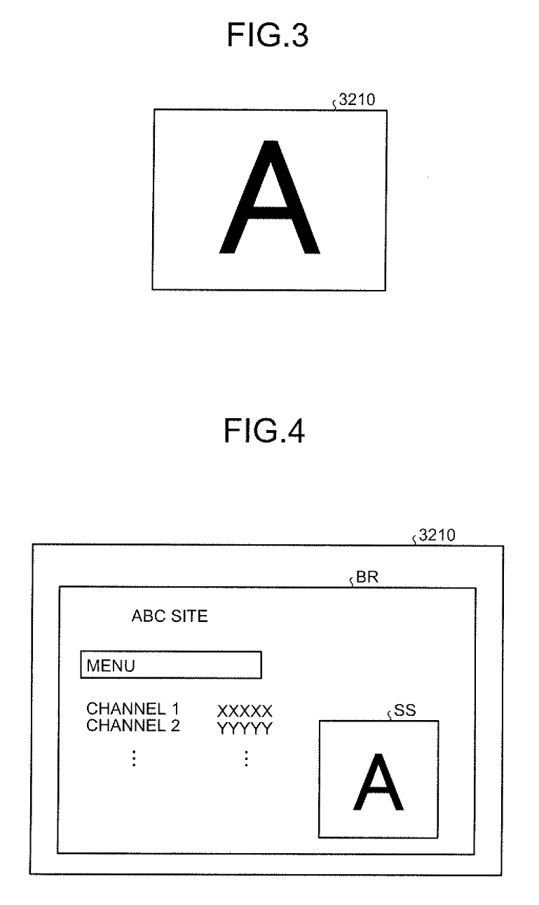

As described above, when the receiving module 3201 receives the first signal indicating that an IP broadcast is to be viewed, the connection processor 3203 issues a join request and thereby receives a program. As illustrated in FIG. 3, after being decoded by the AV processor 3205, the program is displayed by the AV output module 3207 on the entire screen of the display device 3210.

On the other hand, when determining that the receiving module 3201 has not received the first signal but has received the second signal, the connection processor 3203 invokes the browser stored in the storage module 3202, and connects to a portal site of the portal server 110.

The connection processor 3203 then receives a script or the like from the portal server 110 to display a Web page of the portal site. Thereafter, the connection processor 3203 issues a join request to connect to the IP broadcast server 120 with a multicast address described in the script. Thus, the connection processor 3203 receives a program of a channel in response to the join request.

As described above, when the receiving module 3201 receives the second signal instructing to connect to a portal site, the connection processor 3203 issues a join request and thereby receives a program. As illustrated in FIG. 4, the program is displayed in a sub window SS on a browser screen BR displayed on the display device 3210, which will be described later.

Further, upon invoking the browser, the connection processor 3203 determines whether the receiving module 3201 has received the first signal. When determining that the receiving module 3201 has received the first signal under the condition where the browser is active, in the same manner as previously described for the case where the receiving module 3201 has received the first signal, the connection processor 3203 reads a channel stored in the storage module 3202. Then, the connection processor 3203 issues a join request to connect to the IP broadcast server 120 with a multicast address corresponding to the channel read from the storage module 3202. Thus, the connection processor 3203 receives a program from the IP broadcast server 120 to which the connection processor 3203 has sent the join request.

Besides, when the determination module 3204, which will be described later, stores the last channel, the connection processor 3203 issues a leave request to stop receiving the program.

The connection processor 3203 receives, as an IP broadcast program, video and audio signals that constitute the program. Incidentally, it is assumed that, in addition to the video and audio signals, the connection processor 3203 receives the stream distribution of various types of service information defined by the association of radio industries and business (ARIB) standard, such as information indicating an IP broadcast channel and a transmission path from the IP broadcast server 120 to the receiver 320. Referring back to FIG. 2, the determination module 3204 will be described.

The determination module 3204 determines whether the receiving module 3201 has received a power OFF signal. When the receiving module 3201 has received a power OFF signal, the determination module 3204 determines whether a program of a channel being received by the connection processor 3203 is displayed through the browser, i.e., whether it has been notified that an IP broadcast is viewed. Only when determining that the program is not displayed through the browser, the determination module 3204 stores the last channel in the storage module 3202.

This is because, in the case where an IP broadcast program is received through the browser, the receiver 320 receives both a program, which is received when accessing a portal site (the program displayed in the sub window SS illustrated in FIG. 4), and a program, which is received when it has been notified that an IP broadcast is viewed (the program displayed on the display device 3210 illustrated in FIG. 3), by multicast communication. In other words, while the program illustrated in FIG. 3 is actually being viewed by the user, the program illustrated in FIG. 4 may be, for example, a promotion program, and is not always viewed by the user.

Since the receiver 320 receives both the programs by multicast communication, if a channel is simply stored, the channel of a program that the user has not viewed may be stored as the last channel. Next, the AV processor 3205 will be described.

The AV processor 3205 decodes video and audio signals of an IP broadcast program or the like received by the connection processor 3203 as well as demodulating service information such as a multiplexed electronic program guide (EPS).

The graphics processor 3206 combines the video and audio signals decoded by the AV processor 3205, various messages in, for example, hypertext markup language (HTML) or broadcast markup language (BML) on the browser, the EPS, and the like to thereby generate display data.

The AV output module 3207 outputs the video and audio signals decoded by the AV processor 3205 or the display data generated by the graphics processor 3206 to the display device 3210 and the audio output device 3211 connected to the receiver 320.

The communication module 3208 comprises a network Interface card, and intermediates communication between the receiver 320 and the like and the home gateway 310.

The controller 3209 controls the operation of the above modules such as the receiving module 3201 and the connection processor 3203.

The display device 3210 includes, for example, a liquid crystal display (LCD), and displays video or the like output from the AV output module 3207.

The audio output device 3211 includes, for example a speaker, and outputs audio or the like output from the AV output module 3207.

Although the display device 3210 and the audio output device 3211 are described herein as devices separate from the receiver 320, they may be built in the receiver 320.

Referring back to FIG. 1, the network 400 is a communication network such as a wide area network (WAN). A description will now be given of a process performed by the receiver 320 from when it receives an IP broadcast program or the like until it stores the last channel of the IP broadcast.

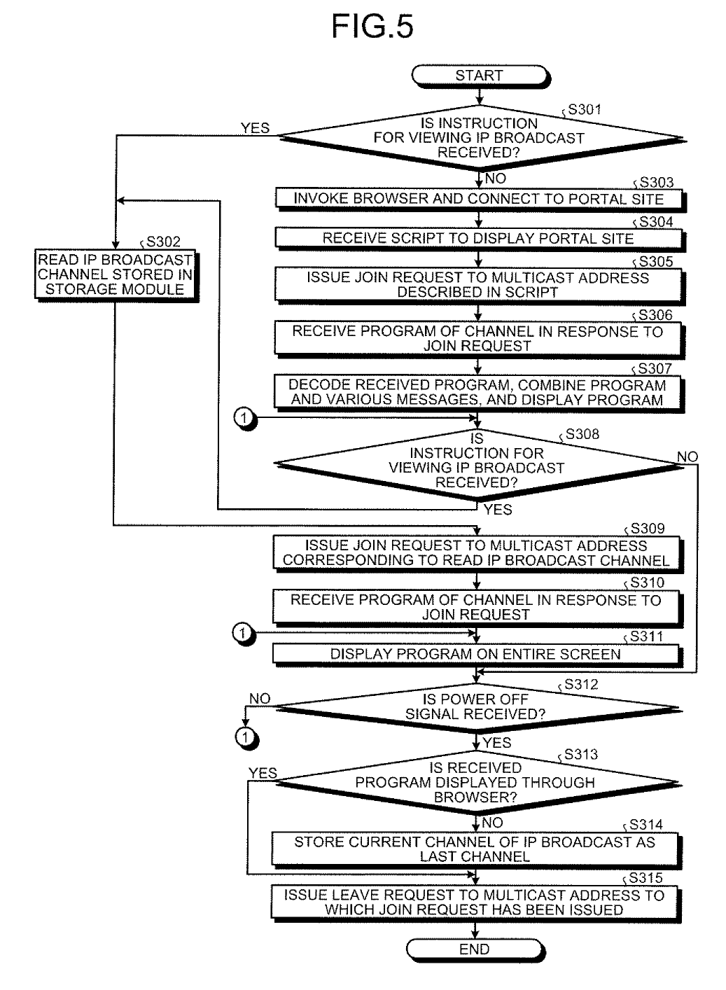

FIG. 5 is a flowchart of the process performed by the receiver 320 from when it receives an IP broadcast program or the like until it stores the last channel of the IP broadcast. In the following, it is assumed that the user has brought the receiver 320 from power OFF mode to power ON mode.

As illustrated in FIG. 5, the connection processor 3203 determines whether the signal received by the receiving module 3201 is the first signal or the second signal (S301). When determining that the receiving module 3201 has received the first signal (Yes at S301), the connection processor 3203 reads a channel stored in the storage module 3202 (S302). Then, the process moves to S309.

On the other hand, when determining that the receiving module 3201 has not received the first signal but has received the second signal (No at S301), the connection processor 3203 invokes the browser stored in the storage module 3202, and connects to a portal site of the portal server 110 (S303).

The connection processor 3203 then receives a script from the portal server 110 to display a Web page of the portal site (S304). Thereafter, the connection processor 3203 issues a join request to connect to the IP broadcast server 120 with a multicast address described in the script (S305). Thus, the connection processor 3203 receives a program of a channel in response to the join request (S306).

After that, the AV processor 3205 decodes the received program. The graphics processor 3206 combines the program and various messages on the browser to generate program data, and the AV output module 3207 outputs or displays the program data (S307).

Then, the connection processor 3203 determines whether the receiving module 3201 has received the first signal (S308). When the connection processor 3203 determines that the receiving module 3201 has received the first signal (Yes at S308), as in the case of S301, the process moves to S302.

Thereafter, the connection processor 3203 issues a join request to connect to the IP broadcast server 120 with a multicast address corresponding to the read channel (S309). Thus, the connection processor 3203 receives a program from the IP broadcast server 120 to which it has sent the join request (S310). The AV processor 3205 decodes the received program, and the AV output module 3207 displays the program on the entire screen of the display device 3210 (S311). Then, the process moves to S312.

On the other hand, when the connection processor 3203 determines that the receiving module 3201 has not received the first signal (No at S308), the process moves to S312.

Upon completion of the process at S308 or S311, the determination module 3204 determines whether the receiving module 3201 has received a power OFF signal (S312). When determining that the receiving module 3201 has received a power OFF signal (Yes at S312), the determination module 3204 further determines whether a program of a channel being received by the connection processor 3203 is displayed through the browser (S313).

Having determined that the program is not displayed through the browser (No at S313), the determination module 3204 stores the last channel in the storage module 3202 (S314). On the other hand, when the determination module 3204 determines that the program is displayed through the browser (Yes at S313), the process moves to S315 without any operation.

Besides, when the determination module 3204 determines that the receiving module 3201 has not received a power OFF signal (No at S312), and if the receiving module 3201 has received the first signal (Yes at S308), the process returns to S311. If the receiving module 3201 has not received the first signal (No at S308), the process moves to S312.

Upon completion of the process at S313 or S314, the connection processor 3203 issues a leave request to stop receiving the program (S315). After that, this process ends.

As described above, according to the first embodiment, the storage module 3202 stores a channel of a program. The receiving module 3201 receives input specifying a program to be viewed by the user selected from a plurality of programs. The connection processor 3203 receives a program to be viewed by the user or a program that the user does not intend to view and that is automatically transmitted from the IP broadcast server 120. The display device 3210 displays the program to be viewed by the user or the program that the user does not intend to view and that is automatically transmitted from the IP broadcast server 120. The determination module 3204 determines whether the program displayed on the display device 3210 is the one viewed by the user. When determining that the program displayed on the display device 3210 is the one viewed by the user, the determination module 3204 stores the channel of the program in the storage module 3202. Thus, the last channel can be properly stored.

While, in the first embodiment, the last channel is described as being stored at the time a power OFF signal is received, this is by way of example only. The last channel may be stored at the time a channel is selected to receive an IP broadcast program without a determination as to whether a power OFF signal is received. In this case, the last channel can be properly stored even when the power is cut accidentally.

In the first embodiment described above, in the case where the receiver 320 receives an IP broadcast, the channel of an IP broadcast program is stored as the last channel only when the browser is not active. However, there is a case where the user once accesses a portal site, and then views an IP broadcast after switching the display between the main window and the sub window on the browser so that a program displayed in the sub window is displayed in the main window. According to a second embodiment of the invention, when the user switches the display in such a manner, the channel of an IP broadcast program displayed in the main window is stored as the last channel even if the browser is active.

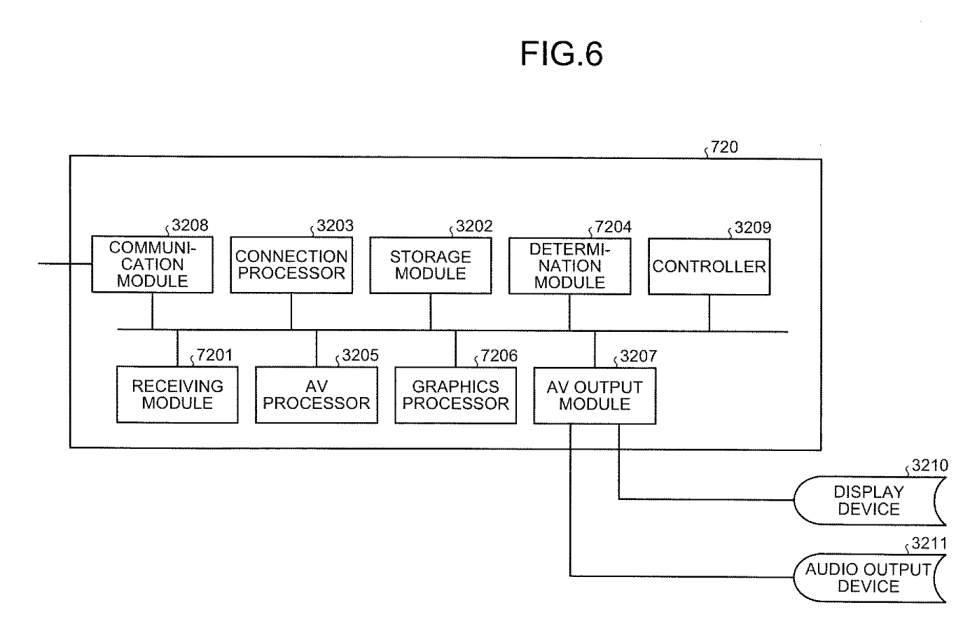

FIG. 6 is a functional block diagram of a receiver 720 according to the second embodiment. As illustrated in FIG. 6, differently from the receiver 320 of the first embodiment, the receiver 720 of the second embodiment comprises a receiving module 7201, a determination module 7204, and a graphics processor 7206, which are different from the receiving module 3201, the determination module 3204, and the graphics processor 3206 of the first embodiment. Otherwise, the receiver 720 is basically similar to the receiver 320. Therefore, the constituent elements corresponding to those of the first embodiment are designated by the same reference numerals, and their description will not be repeated.

The receiving module 7201 performs the same processing as performed by the receiving module 3201 of the first embodiment. In addition, while the browser is active, the receiving module 7201 receives an instruction to switch the display between a main window MS on the browser to display a program that the user views, which will be described later, and the sub window SS to display, for example, a promotion program.

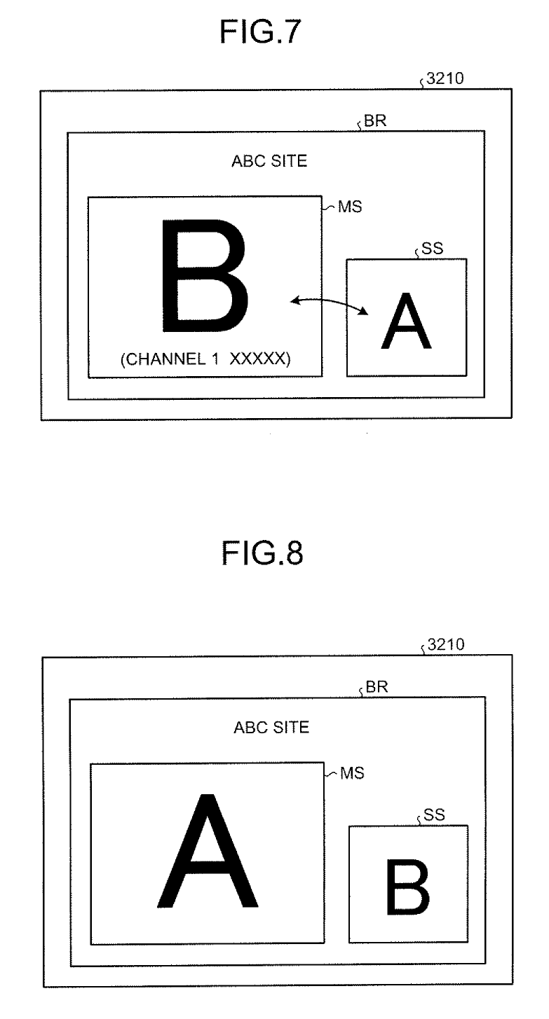

More specifically, when the user invokes the browser and accesses a portal site, if he/she selects Channel 1 (program XXXXX) from the menu illustrated in FIG. 3, the graphics processor 7206, which will be later, displays the program received by the connection processor 3203 in the main window MS as illustrated in FIG. 7. At this point, the sub window SS displays another program (for example, a promotion program).

Under such a condition, if the receiving module 7201 receives an instruction to switch the display between the main window MS and the sub window SS so that the program displayed in the sub window SS is displayed in the main window MS, as illustrated in FIG. 8, the program displayed in the main window MS is replaced with that displayed in the sub window SS.

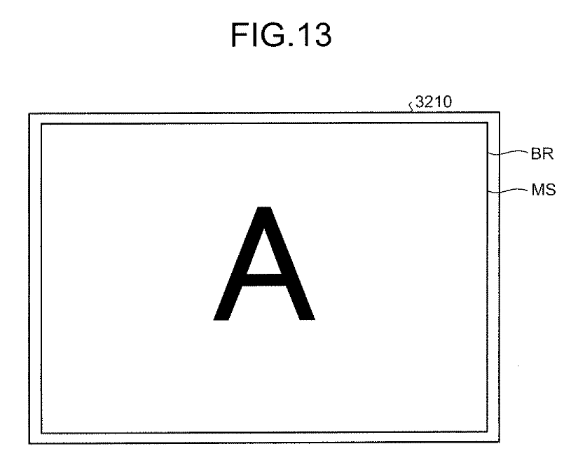

In this manner, the receiving module 7201 switches the display between the main window MS and the sub window SS. Incidentally, the display in the main window MS may be displayed on the entire screen of the browser BR as illustrated in FIG. 13 as full-screen display. Referring back to FIG. 6, the determination module 7204 will be described.

The determination module 7204 performs the same processing as performed by the determination module 3204 of the first embodiment. In addition, the determination module 7204 determines whether a program received by the connection processor 3203 is displayed i) on the entire screen or in the main window MS or ii) in the sub window SS. Only when determining that the program is displayed i) on the entire screen or in the main window MS, the determination module 7204 stores the last channel in the storage module 3202.

The graphics processor 7206 performs the same processing as performed by the graphics processor 3206 of the first embodiment. In addition, when the determination module 7204 determines that a program received by the connection processor 3203 is displayed through the browser, the graphics processor 7206 generates display data so that the program received by the connection processor 3203 is displayed in the main window MS on the browser. The AV output module 3207 displays the display data generated by the graphics processor 7206 on the display device 3210.

Besides, the graphics processor 7206 determines whether the receiving module 7201 has received an instruction to switch the display from the sub window SS to the main window MS. When determining that the receiving module 7201 has received an instruction to switch the display, the graphics processor 7206 displays a program displayed in the sub window SS in the main window MS. Meanwhile, the graphics processor 7206 displays a program displayed in the main window MS in the sub window SS.

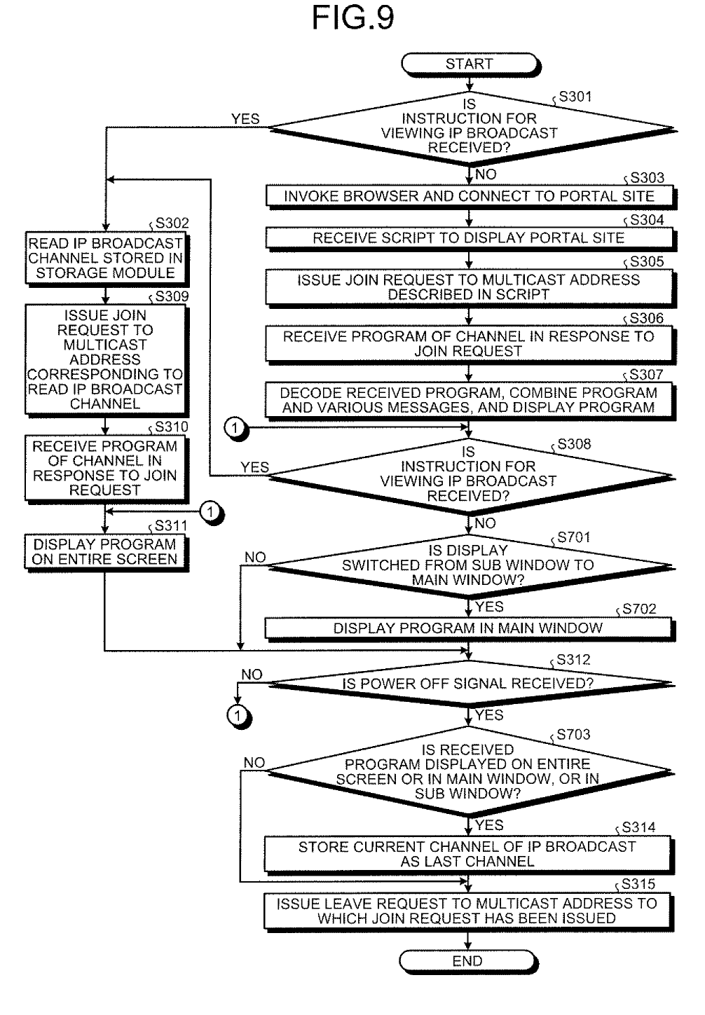

A description will now be given of the operation of the receiver 720 according to the second embodiment. FIG. 9 is a flowchart of the process performed by the receiver 720 from when it receives an IP broadcast program or the like until it stores the last channel. The same process as described previously in the first embodiment (S301 to S311, S312, and S314 to S315) will not be described again.

When the connection processor 3203 determines that the receiving module 7201 has not received the first signal (No at S308), to process moves to S701.

The graphics processor 7206 determines whether the receiving module 7201 has received an instruction to switch the display from the sub window SS to the main window MS (S701). When the graphics processor 7206 determines that the receiving module 7201 has received an instruction to switch the display (Yes at S701), to process moves to S702.

The graphics processor 7206 then generates display data so that a program displayed in the sub window SS is displayed in the main window MS. The AV output module 3207 displays the display data generated by the graphics processor 7206 on the display device 3210 (S702).

On the other hand, when the graphics processor 7206 determines that the receiving module 7201 has not received an instruction to switch the display (No at S701), to process moves to S312. After that, the determination module 7204 determines whether a program received by the connection processor 3203 is displayed on the entire screen or in the main window MS, or in the sub window SS (S703). When the determination module 7204 determines that the program is displayed on the entire screen or in the main window MS (Yes at S703), the process moves to S314. The determination module 7204 stores the last channel in the storage module 3202 (S314).

As described above, according to the second embodiment, the main window MS and the sub window SS are displayed on the browser screen. The receiving module 7201 receives an instruction to switch the display between the main window MS and the sub window SS. The determination module 7204 determines whether the receiving module 7201 has received an instruction to switch the display between the main window MS and the sub window SS. When determining that the receiving module 7201 has received an instruction to switch the display between the main window MS and the sub window SS, the determination module 7204 stores the channel of a program displayed in the main window MS in the storage module 3202 even while the browser is active. Thus, the last channel can be stored more properly.

While, in the second embodiment, the last channel is described as being stored at the time a power OFF signal is received, this is by way of example only. The last channel may be stored at the time a channel is selected to receive an IP broadcast program without a determination as to whether a power OFF signal is received.

In the first embodiment described above, in the case where the receiver 320 receives an IP broadcast, the channel of an IP broadcast program is stored as the last channel only when the browser is not active. However, as with broadcast based on the ARIB standard, various types of service information can be received together with video and audio signals by IP broadcast. The service information may indicate that an IP broadcast program is a promotion program as information on the IP broadcast program or the like. According to a third embodiment of the invention, the last channel is stored not depending on whether the browser is active. The channel of a received program is stored as the last channel depending on whether the service information indicates that a program is a promotion program.

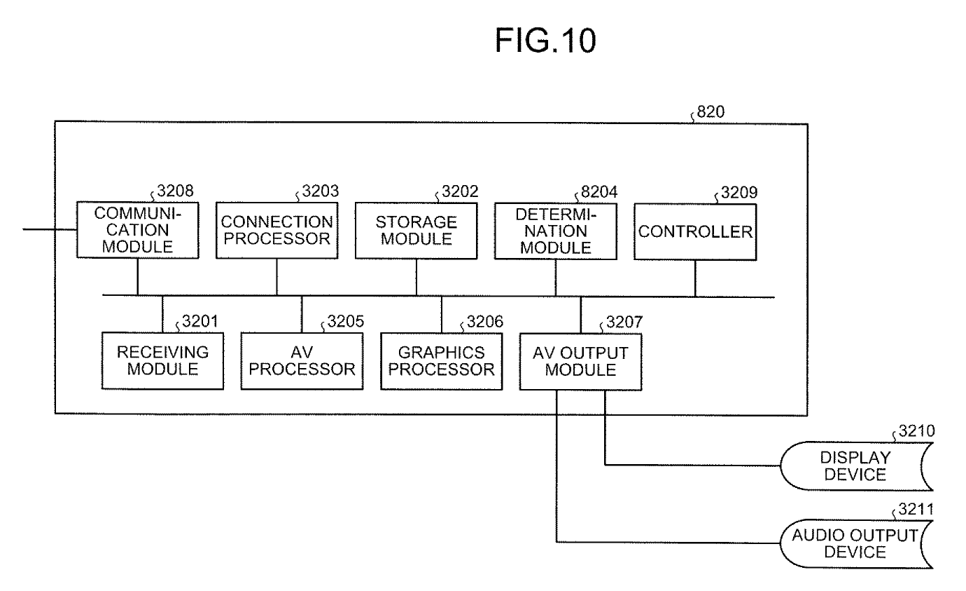

FIG. 10 is a functional block diagram of a receiver 820 according to the third embodiment. As illustrated in FIG. 10, differently from the receiver 320 of the first embodiment, the receiver 820 of the third embodiment comprises a determination module 8204 which is different from the determination module 3204 of the first embodiment. Otherwise, the receiver 820 is basically similar to the receiver 320. Therefore, the constituent elements corresponding to those of the first embodiment are designated by the same reference numerals, and their description will not be repeated.

The determination module 8204 performs the same processing as performed by the determination module 3204 of the first embodiment. In addition, when the receiving module 3201 receives a power OFF signal while the connection processor 3203 is receiving an IP broadcast program, the determination module 8204 reads service information on the IP broadcast program received by the connection processor 3203. The determination module 8204 then determines whether the service information indicates that the IP broadcast program is a promotion program providing information on an IP broadcast program.

For example, when an IP broadcast program is received in the moving picture experts group phase 2-transport stream (MPEG2-TS) format, the determination module 8204 refers to a network information table (NIT), an event information table (EIT) or the like in the service information. Thus, the determination module 8204 determines whether the service information indicates that the IP broadcast program is a promotion program.

Only when determining that the service information does not indicate that the IP broadcast program is a promotion program providing information on an IP broadcast program, the determination module 8204 stores the last channel in the storage module 3202.

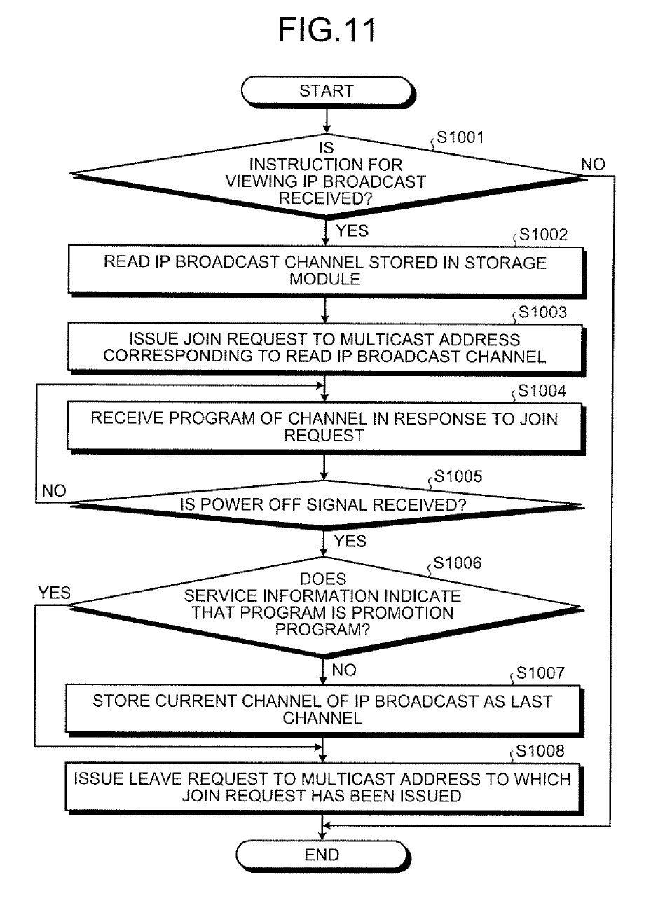

A description will now be given of the operation of the receiver 820 according to the third embodiment. FIG. 11 is a flowchart of the process performed by the receiver 820 from when it receives an IP broadcast program or the like until it stores the last channel. The same process as described previously in the first embodiment (S1001 to S1005 and S1008) will not be described again.

At S1005, when determining that the receiving module 3201 has received a power OFF signal, the determination module 8204 determines whether service information on an IP broadcast program indicates that the IP broadcast program is a promotion program (S1006).

When determining that the service information on the IP broadcast program does not indicate that the IP broadcast program is a promotion program (No at S1006), the determination module 8204 stores the last channel in the storage module 3202 (S1007).

On the other hand, when the determination module 8204 determines that the service information on the IP broadcast program indicates that the IP broadcast program is a promotion program (Yes at S1006), the process moves to S1008.

At S1008, the connection processor 3203 issues a leave request. After that, this process ends.

As described above, according to the third embodiment, a program is received together with service information indicating whether the program is a promotion program. The determination module 8204 determines whether the service information received together with the program by the connection processor 3203 indicates that the program is a promotion program. When determining that the service information received together with the program by the connection processor 3203 does not indicate that the program is a promotion program, the determination module 8204 stores the channel of the program in the storage module 3202. Thus, regardless of whether the program is viewed on the receiving side, the last channel can be properly stored.

In the third embodiment described above, instead of determining whether the browser is active, it is determined whether service information received together with an IP broadcast program indicates that the IP broadcast program is a promotion program. Only when the service information does not indicate that the IP broadcast program is a promotion program, the determination module 8204 stores the last channel in the storage module 3202.

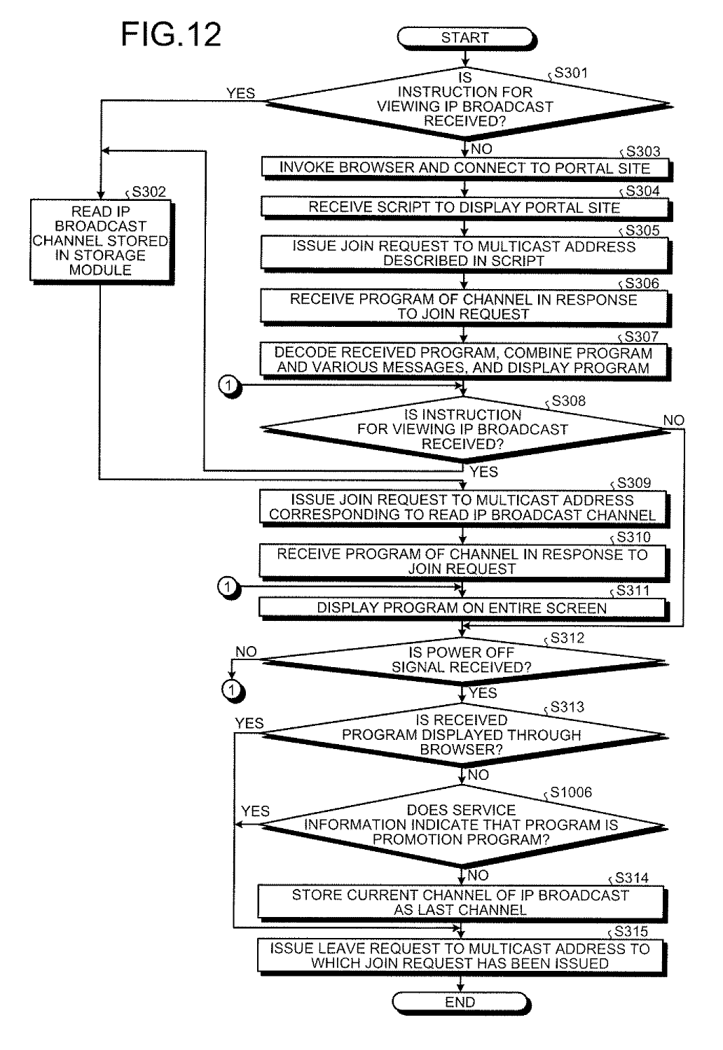

However, the last channel may be stored in different manners. For example, as illustrated in FIG. 12, the process at S1006 described previously in the third embodiment may be performed after the process at S313 described previously in the first embodiment. In this case, only when a program is not received through the browser, and also service information received together with the program does not indicate that the program is a promotion program, the last channel is stored in the storage module 3202. With this, the channel of an IP broadcast program can be stored as the last channel to fit user intention.

While, in the third embodiment, the last channel is described as being stored at the time a power OFF signal is received, this is by way of example only. The last channel may be stored at the time a channel is selected to receive an IP broadcast program without a determination as to whether a power OFF signal is received.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A receiver that is connected via a communication network to a broadcast server that transmits a plurality of programs broadcast via the Internet, the receiver comprising:
a storage module configured to store channels of the programs;
a receiving module configured to receive input specifying a first program, from among the programs, to be viewed;
a connection processor configured to receive the first program or a second program that is automatically transmitted from the broadcast server from among the programs;
a display module configured to display the first program or the second program; and
a determination module configured to determine whether the display module displays the first program, and, when determining that the display module displays the first program, store a channel of the first program in the storage module.

2. The receiver of claim 1, wherein
the receiver is configured to be connected via the communication network to a portal server that transmits a site screen including a sub screen to display the second program in response to a request from outside,
the receiving module is configured to receive an instruction to display the site screen,
the storage module is configured to store an application program to display the site screen on the display module,
when the receiving module receives an instruction to display the site screen, the connection processor invokes the application program and receives the second program while the application program is active, and
the connection processor is configured to determine whether the application program is active, and, when determining that the application program is not active, store the channel of the first program in the storage module.

3. The receiver of claim 2, wherein the site screen further includes a main screen, the receiver further comprising:
a graphics processor configured to display the first program received by the connection processor on the main screen, wherein
when the first program is displayed on the main screen, the determination module stores the channel of the first program in the storage module.

4. The receiver of claim 3, wherein
the receiving module is configured to receive an instruction to switch display between the main screen and the sub screen, and
the determination module is configured to determine whether the receiving module receives an instruction to switch display between the main screen and the sub screen, and, when determining that the receiving module receives the instruction, store the channel of the first program in the storage module even while the application program is active.

5. The receiver of claim 4, wherein the instruction is to switch display from the sub screen to the main screen.

6. The receiver of claim 1, wherein
the first program or the second program includes service information indicating that the first program or the second program is a promotion program, and
the determination module is configured to determine whether service information included in a program received by the connection processor indicates that the program is a promotion program, and, when determining that the service information does not indicate that the program is a promotion program, store the channel of the first program in the storage module.

7. The receiver of claim 6, wherein
the first program or the second program is transmitted in a moving picture experts group phase 2-transport stream format, and
the determination module is configured to refer to a network information table and an event information table as the service information to determine whether the service information included in the program received by the connection processor indicates that the program is a promotion program.

8. The receiver of claim 1, wherein the first program or the second program is transmitted by multicast communication.

9. A receiving method applied to a receiver that is connected via a communication network to a broadcast server that transmits a plurality of programs broadcast via the Internet and that comprises a storage module configured to store channels of the programs and a display module configured to display a first program specified from among the programs or a second program automatically transmitted from the broadcast server, the receiving method comprising:
a receiving module receiving input specifying the first program to be viewed;
a connection processor receiving the first program or the second program; and
determination module determining whether the display module displays the first program, and, when determining that the display module displays the first program, storing a channel of the first program in the storage module.
